(19) United States
(12) Patent Application Publication
(10) Pub. No.: US 2026/0154503 A1
(43) Pub. Date: Jun. 4, 2026

(54) METHOD AND SYSTEM FOR RETRIEVING TARGETED INFORMATION FROM A DOCUMENT BY A LARGE LANGUAGE MODEL

(71) Applicant: JPMorgan Chase Bank, N.A., New York, NY (US)

(72) Inventors: Sanjay KARIYAPPA, Mountain View, CA (US); Freddy LECUE, Mamaroneck, NY (US); Faisal HAMMAN, Hyattsville, MD (US)

(73) Assignee: JPMorgan Chase Bank, N.A., New York, NY (US)

(21) Appl. No.: 18/968,291

(22) Filed: Dec. 4, 2024

(51) Int. Cl. G06F 40/284

(52) U.S. Cl. CPC G06F 40/284

(57) ABSTRACT

A method and system for retrieving targeted information from a document by a large language model (LLM). The method includes receiving a document and a query for targeted information; tagging the document with sentence tags; splitting the tagged document into first and second segments; implementing a LLM; and assigning the first segment and the second segment to the LLM in a chronological order. The method also includes instructing the LLM to identify and select a first set of relevant tokens within the first segment and identify and select a second set of relevant tokens within the second segment, performing a prompt-based approach or an attention-based approach that highlights relevant tokens by the LLM from the first set of relevant tokens and from the second set of relevant tokens, and providing an output of the targeted information from the LLM.

### FIELD OF THE DISCLOSURE

This technology generally relates to methods and systems for retrieving targeted information from a document by a large language model.

### BACKGROUND INFORMATION

Large Language Models (LLMs) are increasingly being used to automate grounded generation tasks such as information retrieval (e.g., with textual data), fact-checking, and question answering. However, these grounded generation tasks often involve the use of lengthy documents, i.e., long documents with large token lengths. Thus, while LLMs have been widely utilized in performing such tasks, a critical issue exists challenging their performance. Notably, that with these types of tasks, the performance of the LLM typically degrades with long-context inputs with drastic degradations at very high document token lengths.

Accordingly, there is a need for techniques to optimize the LLMs' performance when it performs grounded generation task that involve retrieving information from large documents.

### SUMMARY

The present disclosure, through one or more of its various aspects, embodiments, and/or specific features or sub-components, provides, inter alia, various systems, servers, devices, methods, media, programs, and platforms for retrieving targeted information from a document by a large language model.

According to an aspect of the present disclosure, a method of retrieving targeted information from a document by a large language model may be provided. The method may be implemented by at least one processor. The method may include receiving a document having a token length that is greater than a predetermined token length and receiving a query for targeted information associated with the document, tagging the document with a plurality of sentence tags, and splitting the tagged document into a plurality of segments that may include a first segment and a second segment.

The method may also include implementing a large language model (LLM), assigning the first segment and the second segment to the LLM in a chronological order, and instructing the LLM to identify and select a first set of relevant tokens within the first segment and then further instructing the LLM to identify and select a second set of relevant tokens within the second segment.

The method may also include performing at least one from among a prompt-based approach and an attention-based approach that highlights relevant tokens by the LLM from the first set of relevant tokens and from the second set of relevant tokens, and providing an output of the targeted information from the LLM based on an extraction of the highlighted relevant tokens that is responsive to the query.

The splitting the tagged document may comprise including a sentence from an end portion of a previous segment into a current segment. Each of the first segment and the second segment may have a predetermined chunk token length. The selecting the first set of the relevant tokens and the second set of the relevant tokens within the first segment and the second segment comprises selecting predetermined top-k relevant tokens.

The prompt-based approach may include attaching a predetermined marker to the relevant tokens, and instantiating the LLM to highlight the relevant tokens based on the attached predetermined marker.

The attention-based approach may include performing a multi-head attention steering mechanism on a respective layer of the LLM and by modifying attention weights associated with the relevant tokens based on a predetermined multi-head attention function with a predetermined scaling vector, and highlighting the relevant tokens by the LLM based on the modified attention weights.

The output may include an intact version of the plurality of sentence tags.

According to another embodiment, a computing apparatus for retrieving targeted information from a document by a large language model may be provided. The computing apparatus may include: a processor; a memory; a display; and a communication interface coupled to each of the processor, the memory, and the display.

The processor may be configured to receive a document having a token length that is greater than a predetermined token length and receive a query for targeted information associated with the document, tag the document with a plurality of sentence tags, and split the tagged document into a plurality of segments that may include a first segment and a second segment.

The processor may also be configured to implement a large language model (LLM), assign the first segment and the second segment to the LLM in a chronological order, and instruct the LLM to identify and select a first set of relevant tokens within the first segment and then further instruct the LLM to identify and select a second set of relevant tokens within the second segment.

The processor may also be configured to perform at least one from among a prompt-based approach and an attention-based approach that highlights relevant tokens by the LLM from the first set of relevant tokens and from the second set of relevant tokens, and provide an output of the targeted information from the LLM based on an extraction of the highlighted relevant tokens that is responsive to the query.

The splitting of the tagged document may comprise including a sentence from an end portion of a previous segment into a current segment. Each of the first segment and the second segment may have a predetermined chunk token length. The selecting the first set of the relevant tokens and the second set of the relevant tokens within the first segment and the second segment comprises selecting predetermined top-k relevant tokens.

The processor may be further configured to perform the prompt-based approach by: attaching a predetermined marker to the relevant tokens, and instantiating the LLM to highlight the relevant tokens based on the attached predetermined marker.

The processor may be further configured to perform the attention-based approach by: performing a multi-head attention steering mechanism on a respective layer of the LLM and by modifying attention weights associated with the relevant tokens based on a predetermined multi-head attention function with a predetermined scaling vector, and highlighting the relevant tokens by the LLM based on the modified attention weights.

The output includes an intact version of the plurality of sentence tags.

According to yet another embodiment, non-transitory computer readable storage medium storing instructions for retrieving targeted information from a document by a LLM may be provided. The non-transitory computer readable storage medium may include executable code which, when executed by a processor, may cause the processor to receive a document having a token length that is greater than a predetermined token length and receive a query for targeted information associated with the document, tag the document with a plurality of sentence tags, and split the tagged document into a plurality of segments that may include a first segment and a second segment.

The non-transitory computer readable storage medium may further cause the processor to implement a large language model (LLM), assign the first segment and the second segment to the LLM in a chronological order, and instruct the LLM to identify and select a first set of relevant tokens within the first segment and then further instruct the LLM to identify and select a second set of relevant tokens within the second segment.

The non-transitory computer readable storage medium may further cause the processor to perform at least one from among a prompt-based approach and an attention-based approach that highlights relevant tokens by the LLM from the first set of relevant tokens and from the second set of relevant tokens, and provide an output of the targeted information from the LLM based on an extraction of the highlighted relevant tokens that is responsive to the query.

The splitting of the tagged document may comprise including a sentence from an end portion of a previous segment into a current segment. Each of the first segment and the second segment may have a predetermined chunk token length. The selecting the first set of the relevant tokens and the second set of the relevant tokens within the first segment and the second segment may include selecting predetermined top-k relevant tokens. The output may include an intact version of the plurality of sentence tags.

The non-transitory computer readable storage medium may further cause the processor to perform the prompt-based approach by attaching a predetermined marker to the relevant tokens, and instantiating the LLM to highlight the relevant tokens based on the attached predetermined marker.

The non-transitory computer readable storage medium may further cause the processor to perform the attention-based approach by performing a multi-head attention steering mechanism on a respective layer of the LLM and by modifying attention weights associated with the relevant tokens based on a predetermined multi-head attention function with a predetermined scaling vector, and highlighting the relevant tokens by the LLM based on the modified attention weights.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a system diagram of a computer system.

FIG. 2 illustrates a network diagram of a network environment.

FIG. 3 illustrates a diagram of a system environment according to an embodiment for retrieving targeted information from a document by a large language model (LLM).

FIG. 4 illustrates a flowchart of a process diagram for retrieving targeted information from a document by the LLM according to an embodiment.

FIG. 5 illustrates an example overview process for retrieving targeted information from a document by the LLM according to an embodiment.

FIG. 6 illustrates an example of splitting a document into segments for the LLM according to an embodiment.

FIG. 7 illustrates an example of tagging the segments of the document into segments for the LLM according to an embodiment.

FIG. 8 illustrates example graphs of performance degradation of the LLM based on document token lengths.

### DETAILED DESCRIPTION

Large Language Model (LLM) is increasingly being used to automate grounded generation tasks such as information retrieval (e.g., with textual data), fact-checking, and question answering. However, these grounded generation tasks often involve the use of lengthy documents, i.e., long documents with large token lengths. Thus, while the LLM have been widely utilized in performing such tasks, a critical issue exists challenging their performance. Notably, that with these types of tasks, the performance of the LLM typically degrades with long-context inputs with drastic degradations at very high document token lengths.

Thus, while the LLM have shown impressive zero-shot performance on various grounded generation tasks where the goal is to generate text using an input document or collection of documents as context, the critical issue challenging their performance still exists. With the increasing adoption of the LLM, especially in business settings, there is a growing need to perform such grounded generation tasks on long-context inputs that can include text from multiple source documents, especially in the context of Retrieval Augmented Generation (RAG).

Unfortunately, multiple evaluations on long-context benchmarks have shown that the performance of the LLM often degrades for such tasks as the input document length grows, wherein a reduction in the accuracy of the LLM decreases as the input document length grows. It is hypothesized that this degradation of the LLM's performance may be attributable to the limited attention budget of the LLM. That is, as the input document length grows, the LLM needs to distribute its attention budget over an increasing number of tokens. Since most tokens in the input are irrelevant to completing the grounded generation task, there exists a growing number of distractor tokens in the input. This adversely impacts the LLM in two ways: (1) it degrades the ability of the LLM to identify relevant tokens in the input text and (2) it reduces the amount of attention that can be paid to the relevant tokens in the input.

The present application improves on the status quo and provides a technological improvement by disclosing techniques and processes to improve the performance of the LLM in long-context targeted information retrieval tasks. Notably, the techniques and processes as described in the present application enable the LLM to parse and analyze documents with large token lengths, while still performing with sufficient accuracy and predictive capabilities. That is, the techniques and processes prevents degradation of the LLM's performance when ingesting documents with large token lengths.

The techniques and processes as described in the present application enhances the ability of the LLM to identify and attend to relevant tokens by: (1) identifying relevant tokens and (2) attending via an attention mechanism. Identifying relevant tokens process may occur to find relevant pieces of information more effectively. The identifying process may include dividing the original text into smaller paragraph and processing them using LLM that are called separately to identify and attend to relevant tokens.

The attending process may involve an attention mechanism to attend to the relevant tokens. Once the relevant tokens have been identified, an approach is needed to increase the attention of the LLM over the relevant tokens. One approach may be a prompt-based approach in a black-box setting where a user would primarily have application program interface (API) access to the LLM. In this approach, the LLM may be prompted to indicate the highlighted tokens. In another approach, an attention-based approach in a white-box setting may be implemented using an attention-steering mechanism to amplify the attention weights over the relevant tokens. Thus, providing a steering of the LLM to focus on the relevant tokens.

The techniques as described may be for targeted information retrieval tasks as performed by the LLM. Such targeted information retrieval tasks may include, but is not limited to, grounded question answering, natural language inference (NLI), and passage retrieval, wherein the LLM needs to look for a specific piece of information in a smaller segment of the input context to accomplish the task.

For these various reasons, the present application provides a technological improvement of the status quo because it discloses improved techniques for retrieving targeted information from a document by a LLM. Further details of the present application are provided below.

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

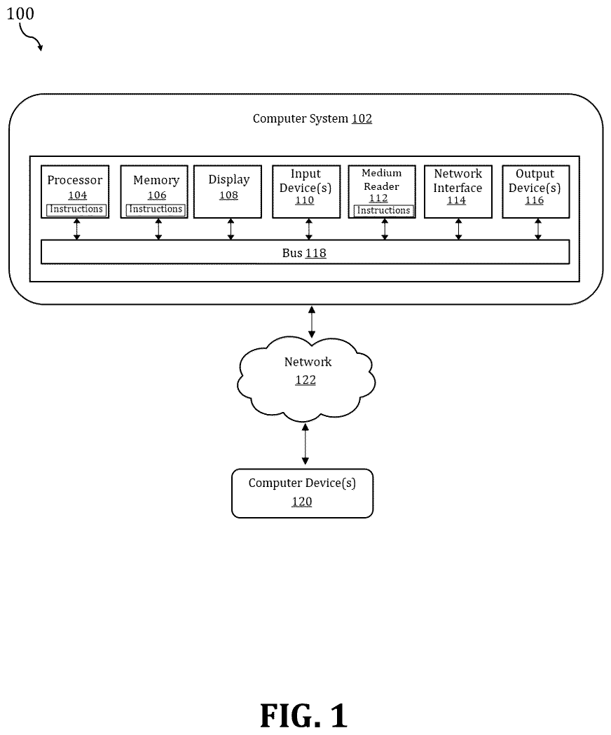

FIG. 1 illustrates a system 100 diagram of a computer system 102 for use in accordance with the embodiments described herein. The system 100 may be generally shown and may include a computer system 102, which may be generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 may be illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 may be an article of manufacture and/or a machine component. The processor 104 may be configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that may store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, digital optical disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed input devices 110 are not meant to be exhaustive and that the computer system 102 may include any additional, or alternative, input devices 110.

The computer system 102 may also include a medium reader 112 which may be configured to read any one or more sets of instructions, e.g., software, from any of the memories described herein. The instructions, when executed by a processor, may be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but not limited to, a local area network, a wide area network, the Internet, a telephony network, a short-range network, or any other network commonly known and understood in the art. The short-range network may include, for example, short-range wireless technology standard used for exchanging data between fixed devices and mobile devices over short distances, low-power wireless ad-hoc mesh networks for linking together, infrared, near field communication, ultra-wideband, or any combination thereof. Those skilled in the art appreciate that additional networks 122 which are known and understood may additionally or alternatively be used and that the networks 122 are not limiting or exhaustive. Also, while the network 122 may be illustrated in FIG. 1 as a wireless network, those skilled in the art appreciate that the network 122 may also be a wired network.

The additional computer device 120 may be illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that may be capable of executing a set of instructions, sequential or otherwise, that specify actions to be taken by that device. Of course, those skilled in the art appreciate that the above-listed devices are merely examples of devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be examples and are not intended to be exhaustive and/or inclusive. Furthermore, the examples of the components listed above are also similarly not meant to be exhaustive and/or inclusive.

In accordance with various embodiments of the present disclosure, the methods described herein may be implemented using a hardware computer system that executes software programs. Further, in a non-limiting embodiment, implementations may include distributed processing, component/object distributed processing, and parallel processing. Virtual computer system processing may be constructed to implement one or more of the methods or functionalities as described herein, and a processor described herein may be used to support a virtual processing environment.

As described herein, various embodiments provide for retrieving targeted information from a document by a LLM.

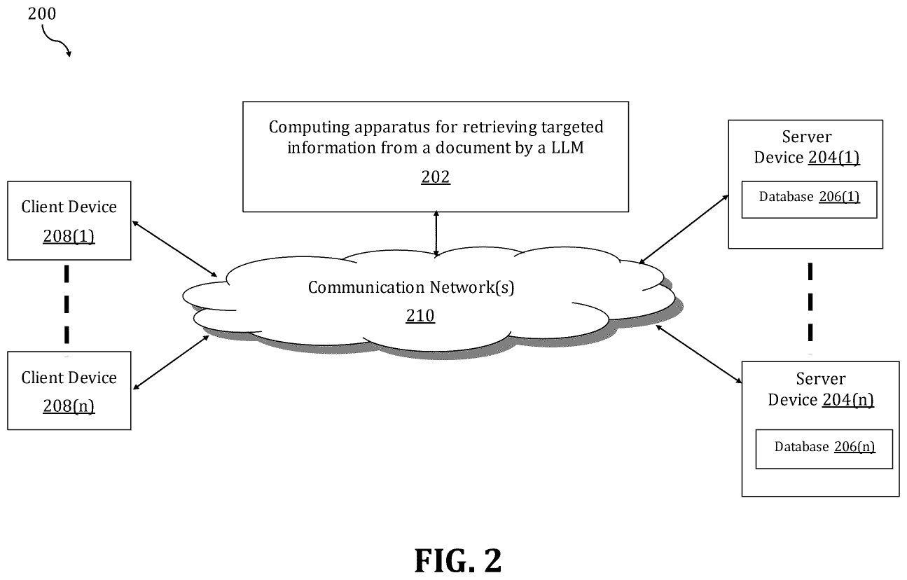

Referring to FIG. 2, a network diagram of a network environment 200 for retrieving targeted information from a document by a LLM may be illustrated. In an embodiment, the method may be executable on any networked computer platform, such as, for example, a personal computer (PC).

The methods for retrieving targeted information from a document by a LLM may be implemented by a computing apparatus 202 that implement a retrieving of targeted information from a document by a LLM. The computing apparatus 202 may be the same or similar to the computer system 102 as described with respect to FIG. 1. The computing apparatus 202 may store one or more applications that may include executable instructions that, when executed by the computing apparatus 202, cause the computing apparatus 202 to perform actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s) may be located in virtual server(s) running in a cloud-based computing environment rather than being tied to one or more specific physical network computing devices. Also, the application(s) may be running in one or more virtual machines (VMs) executing on the computing apparatus 202. Additionally, in one or more embodiments of this technology, virtual machine(s) running on the computing apparatus 202 may be managed or supervised by a hypervisor.

In the network environment 200 of FIG. 2, the computing apparatus 202 may be coupled to a plurality of server devices 204(1)-204(n) that hosts a plurality of databases 206(1)-206(n), and also to a plurality of client devices 208(1)-208(n) via communication network(s) 210. A communication interface of the computing apparatus 202, such as the network interface 114 of the computer system 102 of FIG. 1, operatively couples and communicates between the computing apparatus 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used. The server devices 204(1)-204(n) and/or the client devices 208(1)-208(n) may provide different computing environments.

The communication network(s) 210 may be the same or similar to the network 122 as described with respect to FIG. 1, although the computing apparatus 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and computing apparatus that efficiently implement a method for retrieving targeted information from a document by a LLM.

By way of example only, the communication network(s) 210 may include local area network(s) (LAN(s)) or wide area network(s) (WAN(s)), and may use TCP/IP over Ethernet and industry-standard protocols, although other types and/or numbers of protocols and/or communication networks may be used. The communication network(s) 210 in this example may employ any suitable interface mechanisms and network communication technologies including, for example, tele-traffic in any suitable form (e.g., voice, modem, and the like), Public Switched Telephone Network (PSTNs), Ethernet-based Packet Data Networks (PDNs), combinations thereof, and the like.

The computing apparatus 202 may be a standalone device or integrated with one or more other devices or apparatuses, such as one or more of the server devices 204(1)-204(n), for example. In one particular example, the computing apparatus 202 may include or be hosted by one of the server devices 204(1)-204(n), and other arrangements are also possible. Moreover, one or more of the devices of the computing apparatus 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the computing apparatus 202 via the communication network(s) 210 according to the HTTP-based and/or script object notation protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store information.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that may interact with the computing apparatus 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an embodiment, at least one client device 208 may be a wireless mobile communication device, i.e., a smart phone.

The client devices 208(1)-208(n) may run interface applications, such as standard web browsers or standalone client applications, which may provide an interface to communicate with the computing apparatus 202 via the communication network(s) 210 in order to communicate user requests and information. The client devices 208(1)-208(n) may further include, among other features, a display device, such as a display screen or touchscreen, and/or an input device, such as a keyboard, for example.

Although the network environment 200 with the computing apparatus 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems described herein are for example purposes, as many variations of the specific hardware and software used to implement the examples are possible, as will be appreciated by those skilled in the relevant art(s).

One or more of the devices depicted in the network environment 200, such as the computing apparatus 202, the server devices 204(1)-204(n), or the client devices 208(1)-208(n), for example, may be configured to operate as a virtual instance on the same physical machine. In other words, one or more of the computing apparatus 202, the server devices 204(1)-204(n), or the client devices 208(1)-208(n) may operate on the same physical device rather than as separate devices communicating through communication network(s) 210. Additionally, there may be more or fewer computing apparatus 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only tele-traffic in any suitable form (e.g., voice and modem), wireless traffic networks, cellular traffic networks, Packet Data Networks (PDNs), the Internet, intranets, and combinations thereof.

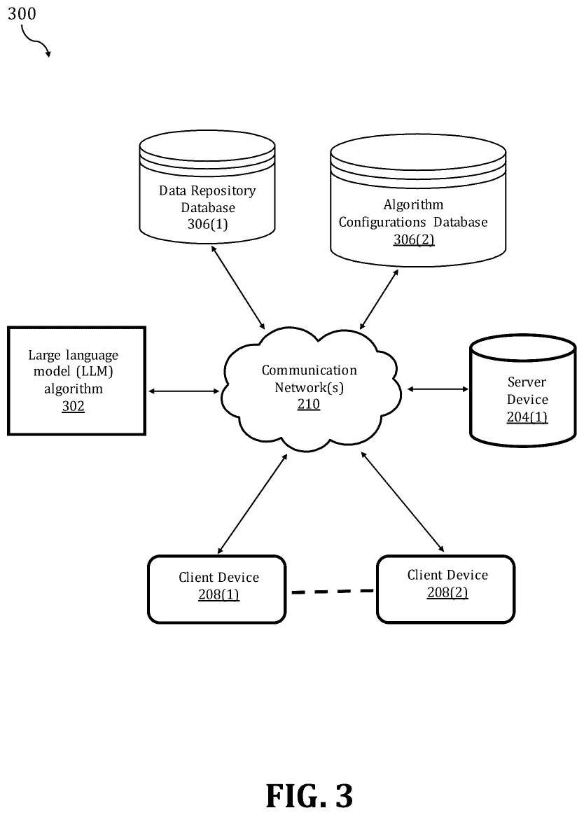

The computing apparatus 202 may be described and illustrated in FIG. 3 as may include a LLM algorithm 302, although it may include other rules, algorithms, policies, modules, databases, or applications, for example. As will be described below, the LLM algorithm 302 may be configured to implement method of retrieving targeted information from a document by a LLM.

FIG. 3 illustrates a diagram of a system environment 300 for implementing method of retrieving targeted information from a document by a LLM by utilizing the network environment of FIG. 2, which may be illustrated as being executed in FIG. 3. Specifically, a first client device 208(1) and a second client device 208(2) are illustrated as being in communication with computing apparatus 202. In this regard, the first client device 208(1) and the second client device 208(2) may be “clients” of the computing apparatus 202 and are described herein as such. Nevertheless, it is to be known and understood that the first client device 208(1) and/or the second client device 208(2) need not necessarily be “clients” of the computing apparatus 202, or any entity described in association therewith herein. Any additional or alternative relationship may exist between either or both of the first client device 208(1) and the second client device 208(2) and the computing apparatus 202, or no relationship may exist.

Further, computing apparatus 202 may be illustrated as being able to access a data repository database 306(1) and an algorithm configurations database 306(2). The LLM algorithm 302 may be configured to access these databases for implementing the method of retrieving targeted information from a document by a LLM.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an embodiment, either or both of the first client device 208(1) and the second client device 208(2) may communicate with the computing apparatus 202 via broadband or cellular communication. Of course, these embodiments are merely examples and are not limiting or exhaustive.

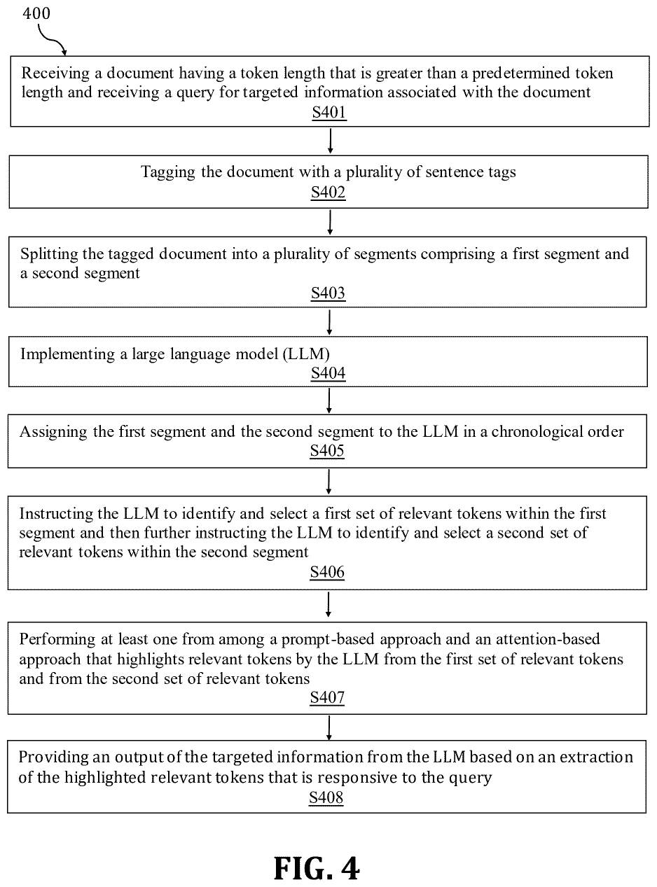

The LLM algorithm 302 may execute a process implementing method of retrieving targeted information from a document by a LLM. The process for retrieving targeted information from a document by a LLM may be generally indicated at flowchart 400 in FIG. 4.

FIG. 4 illustrates a flowchart of a process diagram 400 of a process for of retrieving targeted information from a document by a LLM according to an embodiment. The process diagram 400 may be implemented by the system environment 300 of FIG. 3, a network environment 200 of FIG. 2, and the system 100 of FIG. 1.

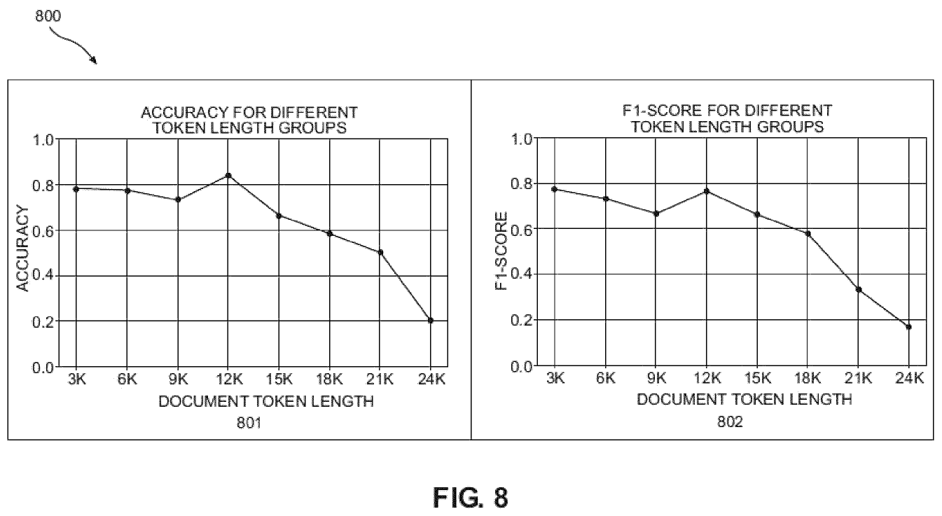

At step S401 of the flowchart process 400, the computing apparatus 202 may receive a document having a token length that is greater than a predetermined token length and receiving a query for targeted information associated with the document. For example, the predetermined token length may be any chosen token length at which performance of the LLM has been judged to be degraded. For example, the predetermined token length may be, but is not limited to, 12K token length because after 12K token length, the performance of the LLM can degrade (see example graphs in FIG. 8 for further details).

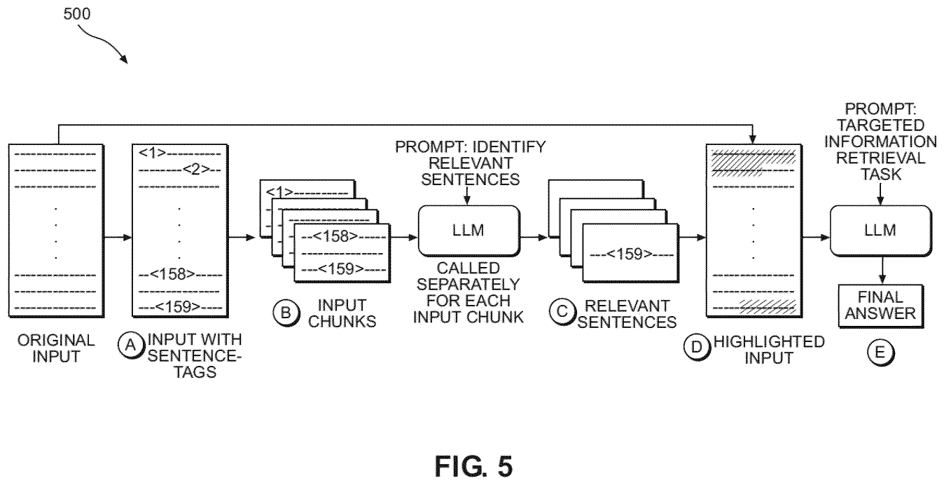

At step S402 of the flowchart process 400, the computing apparatus 202 may tag the document with a plurality of sentence tags. The sentence tags may be a numerical tag that chronologically numbers the sentences. See FIG. 5 for further details.

At step S403 of the flowchart process 400, the computing apparatus 202 may split the tagged document into a plurality of segments comprising a first segment and a second segment. Since the tagged document can be arbitrarily broken into the various segments, this can lead to a loss of context. Thus, the splitting of the tagged document comprises including a sentence from an end portion of a previous segment into a current segment to prevent loss of context. Each of the first segment and the second segment may have a predetermined chunk token length. The predetermined chunk token length is a design choice and may be, e.g., a size of 8K tokens, although it can be of another size as so desired.

At step S404 of the flowchart process 400, the computing apparatus 202 may implement a LLM. That is, the computing apparatus 202 may execute the LLM algorithm 302 to implement the LLM.

At step S405 of the flowchart process 400, the computing apparatus 202 may assign the first segment and the second segment to the LLM in a chronological order. The assignment may be in a chronological order such that a first segment may be assigned to the LLM, followed by a second segment, and so forth up to an m^{th} segment.

At step S406 of the flowchart process 400, the computing apparatus 202 may instruct the LLM to identify and select a first set of relevant tokens within the first segment and then further instruct the LLM to identify and select a second set of relevant tokens within the second segment. The selection of the first set and the second set of relevant tokens within the first segment and the second segment may be based on selecting predetermined top-k relevant tokens. That is, the LLM may be prompted to identify the top-k sentences that are the most relevant. The value of k is a design choice. For example, the k value can be 10, and top-k may then denote top-10 sentences that are the most relevant within the various segments. Further details are provided in FIGS. 5-7.

At step S407 of the flowchart process 400, the computing apparatus 202 may perform at least one from among a prompt-based approach and an attention-based approach that highlights relevant tokens by the LLM from the first set of relevant tokens and from the second set of relevant tokens.

Continuing with step S407, the prompt-based approach may include attaching a predetermined marker to the relevant tokens, and instantiating the LLM to highlight the relevant tokens based on the attached predetermined marker. The predetermined marker is a design choice and may be, e.g., asterisks attached at the beginning and end of a relevant sentence. That is, the relevant sentence may be denoted as so with the attached predetermined markers: **relevant sentence**. The LLM may then highlight the relevant sentence based on the attached predetermined markers serving as signal indicators that a relevant sentence may be present.

Continuing with step S407, the attention-based approach may include performing a multi-head attention steering mechanism on a respective layer of the LLM and by modifying attention weights associated with the relevant tokens based on a predetermined multi-head attention function with a predetermined scaling vector, and highlighting the relevant tokens by the LLM based on the modified attention weights. Further details are provided in FIG. 5.

At step S408 of the flowchart process 400, the computing apparatus 202 may providing an output of the targeted information from the LLM based on an extraction of the highlighted relevant tokens that is responsive to the query. The output may include an intact version of the plurality of sentence tags since the extraction of the highlighted relevant sentences preserves the plurality of sentence tags as they appear within the tagged document.

FIG. 5 illustrates an example overview process 500 for retrieving targeted information from a document by the LLM according to an embodiment as described in FIG. 4 at steps S401-S408. The example overview process 500 may involve processes dubbed divide, highlight, and conquer (DHC).

The example overview process 500 may show an original document for input. The original document may have a token length that is greater than a predetermined token length. At step (a), the document may be tagged with a plurality of sentence tags to transform an original long-context task to shorter-context sub-tasks, resulting in a tagged document. Notably, the sentences in original document may be tagged with a plurality of sentence tags.

The sentence tags may be a numerical tag that chronologically numbers the sentences. For example, a numerical tag from 1 to 159 correlating to 159 sentences as shown in the example overview process 500. In general, the numerical tags range from 1 to m, depending on the total number of sentences in the original document.

At step (b) of the example overview process 500, the tagged document may be split into a plurality of segments such as a first segment and a second segment, up to an m^{th} segment, depending on how much segments the tagged document may be split into. As previously noted, since the tagged document can be arbitrarily broken into the various segments, this can lead to a loss of context. Thus, the splitting of the tagged document comprises including a sentence from an end portion of a previous segment into a current segment to prevent loss of context. That is, the segments may include an additional sentence from the end of the previous segment to provide additional context. Each of the first segment and the second segment may have a predetermined chunk token length. The predetermined chunk token length is a design choice that can be optimized and may be, e.g., a size of 8K tokens, although it can be of another size as so desired.

The LLM may be implemented. The first segment and the second segment may be assigned to the LLM via an input to the LLM, wherein the assignment and input occurs in a chronological order. For example, the assignment and input may be in a chronological order such that a first segment may be assigned and inputted to the LLM, followed by a second segment, and so forth up to an m^{th} segment.

As shown in the example overview process 500, a call function may be performed to call the LLM, which may be called separately for each segment with the predetermined chunk length. The LLM may be instructed (e.g., via a prompt instruction) to identify and select a first set of relevant tokens within the first segment, and then further instructed to identify and select a second set of relevant tokens within the second segment. The LLM may be instructed up to an m^{th} time depending on the total number of segments.

To select and identify the relevant tokens within the various segments, two properties of textual information retrieval tasks, notably targeted textual information retrieval tasks should be considered: sparsity and dispersal. Sparsity may refer to when only a small fraction of tokens from the original input are relevant to the task. Dispersal may refer to relevant information can be dispersed across different parts of the input. Thus, the LLM would need to consider sparse information/data, potentially from different parts of the input in order to correctly solve the textual information retrieval task.

To address these two properties, a two-step technique may be utilized. The first step may include identifying relevant sentences within each segment with the predetermined chunk token length. For each input segment, the LLM may be instructed to identify sentences that are relevant. Since the LLM is identifying relevant sentences for these segments with the predetermined chunk token length, the predetermined chunk token length having smaller-context chunk of information, the ability of the LLM to identify relevant information more accurately is improved because there are fewer distractor tokens in a small segment with chunk of data as compared to the original document with a long token length having a long-context.

It may be noted that a challenge with the first step may be that the LLM's response output may not always match a sentence that was present in the original document, which cause issues when associating the LLM's response to the original input with the original document. To address this issue, the plurality of sentence tags may be implemented. By adding tags to identify sentences (as shown at step (c) in the example overview process 500), the LLM can be forced to output tags in its response, which serve as pointers to the sentences in the original document. This ensures that the LLM's response output would match the sentence(s) that was present in the original document.

The second step may be to pick top-k sentences. Since it may be known that the relevant information may be sparse, all the sentences that have been identified as relevant from the all of the various segments may be considered and the LLM may be instructed to identify the top-k sentences that are the most relevant from all these sentences. The value of k is a design choice. For example, the k value can be 10, and top-k may then denote top-10 sentences that are the most relevant within all the sentences that have been identified as relevant from the all of the various segments. Essentially, top-k is a technique to filter out the most relevant sentences from the all the sentences that have been deemed to be relevant.

At step (d) of the example overview process 500, once the top-k relevant sentences have been identified, the relevant tokens may be highlighted based on either a prompt-based approach or an attention-based approach that highlights relevant tokens. The LLM may be instructed to perform at least one of this approach on the first set of relevant tokens and from the second set of relevant tokens.

The prompt-based approach may be utilized in a black-box setting, wherein access to the LLM may primarily be available via an application program interface (API). That is, a user may just merely have API access to the LLM model rather than access to the internal operation of the LLM itself. Thus, the user may utilize the API access to communicate with the LLM by querying the LLM with a prompt and input data (e.g., the original document) to obtain an output response to the query. In such settings, the attention over the relevant sentences may be indirectly influence using a prompt-based approach. With the prompt-based approach, the attached predetermined markers (e.g., the double asterisks attached to the beginning and end of the relevant sentence) may be utilized to highlight the top-k sentences and prompt the LLM to indicate that the relevant sentences are highlighted.

The attention-based approach may be utilized in a white-box setting, wherein the user may have direct access to an internal operation of the LLM itself. Thus, the user may be able to directly influence the attention mechanism to focus the LLM on the relevant sentences. To accomplish this, a multi-head attention steering mechanism may be utilized. This type of attention steering was initially introduced in the context of instruction following and involves amplifying the LLM's attention on specific instruction tokens, which then enhances the LLM's ability to follow instructions. In the present application, this approach may be used to emphasize relevant sentences. Notably, attention steering can be used to manipulate the attention weights over relevant tokens using scaling factors. Consider, for instance, a self-attention block that produces an attention vector \vec{A}. Let \vec{I} denote a binary vector that indicates relevant tokens. Let α>1 denote a predetermined scaling factor by which it is desired to amplify the original attention. Then, the modified attention weights may be generated as shown below.

$${\vec{A}}^{′} = ( 1 - \vec{I} ) \vec{A} + α \vec{I} \vec{A}$$

$${\vec{A}}^{′} = {\vec{A}}^{′} / {‖ A ‖}_{1}$$

For instance, consider an original multi-head attention equation as shown below. This multi-head attention equation may correlate with a LLM being a transformer type of LLM with various stacked layers that can be represented by the multi-head attention equation. A layer in the stacked layers may denote a predetermined layer.

$${H}^{( l , h )} = {A}^{( l , h )} V = Softmax ( \frac{{QK}^{T}}{\sqrt{{d}_{h}}} ) V$$

In this equation, Q may represent a query matrix, K may represent a key matrix, and V may represent a value matrix that may be projected onto a head h of the LLM. The matrices of K, Q, and V may be: K=XWₖₕ, Q=XW_{qh}, and V=XWᵥₕ. The term X may denote an input and Wₖₕ, W_{qh}, and Wᵥₕ may represent weight matrixes that may be learnable of a head h, wherein Wₖₕ, W_{qh}, and Wᵥₕ∈ [symbol] ^{d×d}^{ₕ} and d×dₕ may denote dimensions. The term A^{(l,h)} may represent attention scores at a head h of a layer l.

Then, a scaled multi-head attention equation with modified attention weights may be generated using the predetermined scaling factor α, i.e., a predetermined multi-head attention function with a predetermined scaling vector. The scaled multi-head attention equation may be shown below, wherein A may denote an attention vector and Cᵢ may denote a normalization constant, and with a values as shown below.

$${H}_{new}^{( l , h )} = {A}_{new}^{( l , h )} V , where$$

$${[ {A}_{new} ]}_{ij} = \{ \begin{matrix}{A}_{ij} / {C}_{i} & if token j is highlighted \\ α {A}_{ij} / {C}_{i} & otherwise\end{matrix}$$

$$α ∈ ( 0 , 1 )$$

Thus, with the attention-based approach, the LLM and its internal operations, including its layers, can be accessed and manipulated. In the present application, the manipulation may be to steer a focus of the LLM on the highlighted relevant tokens based on the scaled multi-head attention equation with the predetermined scaling factor α.

At step (e) of the example overview process 500, the LLM may provide an output of the targeted information based on an extraction of the highlighted relevant tokens that is responsive to the query.

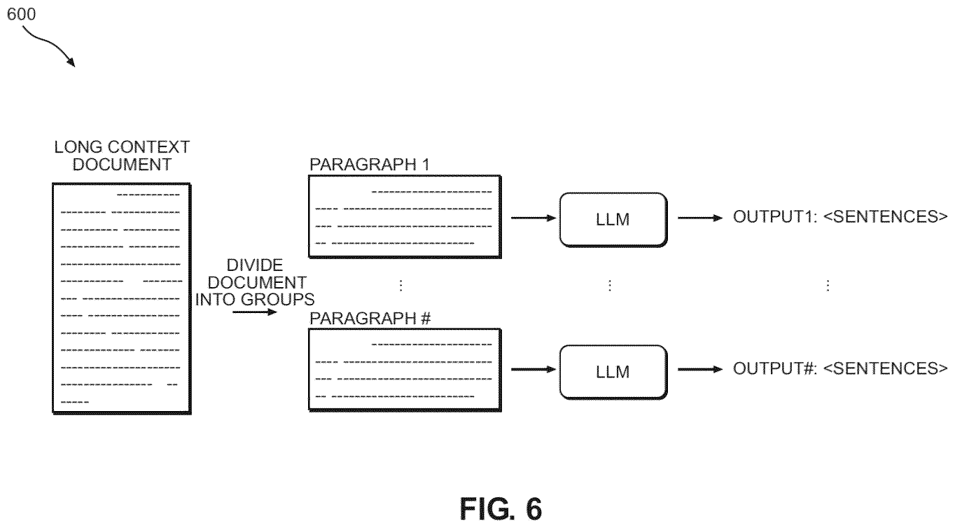

FIG. 6 illustrates an example of splitting 600 a document into segments for the LLM according to an embodiment as described in FIG. 4 at steps S401-S408. The document with a long context, i.e., a document having a token length that is greater than a predetermined token length, may be received. A query prompt for targeted information associated with the document may also be received. An example of the query prompt may be stating that the LLM will be provided with paragraph(s) from a document and a claim statement. The query prompt may also state that the LLM's task may be to identify sentences in the paragraph(s) that help support or refute the claim statement and if there are no sentences output, then to output a response stating “None”.

The example of splitting 600 a document into segments for the LLM may show that the document is divided into different segment groups, with paragraph 1 up to a paragraph # of m. These different segment groups may then be provided to the LLM in order for it to then generate an output response regarding whether the claim statement is supported or unsupported. As previously noted, a call function may be performed to call the LLM, which may be called separately for each segment. The splitting of the document into smaller parts may allow the LLM to process information with a shorter context length.

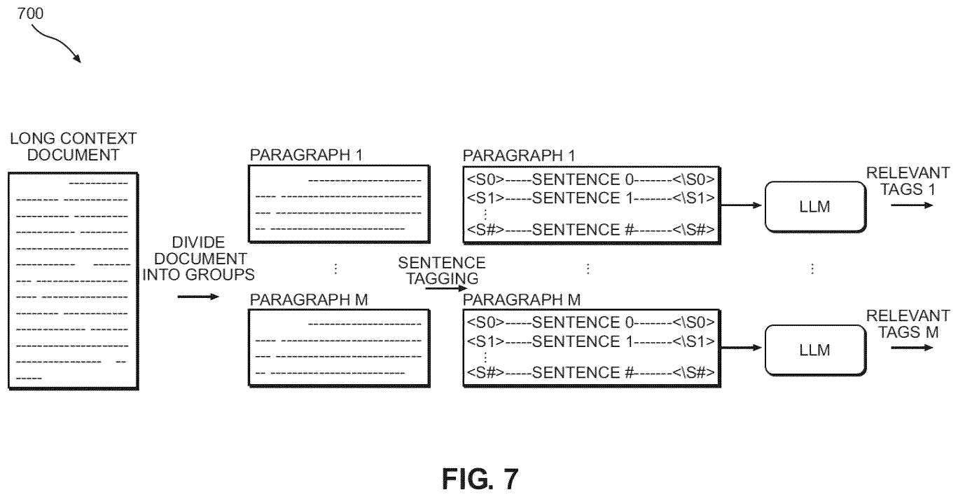

FIG. 7 illustrates an example of tagging 700 the segments of the document into segments for the LLM according to an embodiment according to an embodiment as described in FIG. 4 at steps S401-S408. The document with a long context, i.e., a document having a token length that is greater than a predetermined token length, may be received. A query prompt for targeted information associated with the document may also be received. An example of the query prompt may be stating that the LLM will be provided with paragraph(s) from a document and a claim statement. The query prompt may also state that the LLM's task may be to identify sentences in the paragraph(s) that help support or refute the claim statement and to extract these relevant sentences exactly as they appear, preserving the sentence tags. The query prompt may also state if there are no sentences output, then to output a response stating “None”.

The example of tagging 700 the segments of the document into segments for the LLM may show that the document is divided into different segment groups, with paragraph 1 up to a paragraph # of m. The sentences in the segment groups may be tagged with numerical sentence tags ranging from 1 to a #m. These different segment groups with the tagged sentences may then be provided to the LLM in order for it to then generate an output with relevant token tags. Notably, tagging sentences may help the LLM to pinpoint relevant portions of the document, minimizing the risk of introducing new and potentially fabricated information into the LLM.

FIG. 8 illustrates example graphs 800 of performance degradation of the LLM based on document token lengths. Example graph 801 may show an accuracy performance vs. document token length. It can be seen from the example graph 801 that as the token lengths increase, e.g., from above 12K, the performance accuracy of the LLM starts to decrease, with the performance taking a nosedive at very high token lengths of 24K. Thus, performance significantly drops as document length increases, which is crucial since analytics and predictions can often involve using long documents, i.e., those with high token length values.

Example graph 802 may show a predictive performance of the LLM as measured by a F1-score for different document length groups. The example graph 802 may show F1-scores vs. document token lengths. It can be seen from the example graph 802 that as token lengths increase, e.g., from above 12K, the F1-score of the LLM starts to decrease, with the predictive performance as denoted by the F1-score taking a nosedive at very high token lengths of 24K.

The present application provides advantages over the status quo and technological improvement over the status quo by demonstrating techniques for the LLM to maintain accurate performance and predictive performance when long documents are involved. The present application recites a multi-step process as described above that enables the LLM to efficiently parse and analyze a long document and accurately generate an output response.

Although the invention has been described with reference to several embodiments, it is understood that the words that have been used are words of description and illustration, rather than words of limitation. Changes may be made within the purview of the attached claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the attached claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that may be capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting embodiment, the computer-readable medium may include a solid-state memory such as a memory card or other package that houses one or more non-volatile read-only memories. Further, the computer-readable medium may be a random-access memory or other volatile re-writable memory. Additionally, the computer-readable medium may include a magneto-optical or optical medium, such as a disk or tapes or other storage device to capture carrier wave signals such as a signal communicated over a transmission medium. Accordingly, the disclosure may be considered to include any computer-readable medium or other equivalents and successor media, in which data or instructions may be stored.

Although the present application describes specific embodiments which may be implemented as computer programs or code segments in computer-readable media, it may be understood that dedicated hardware implementations, such as application specific integrated circuits, programmable logic arrays and other hardware devices, may be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the attached claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method of retrieving targeted information from a document by a large language model, the method being implemented by at least one processor, the method comprising:
receiving a document having a token length that is greater than a predetermined token length and receiving a query for targeted information associated with the document;
tagging the document with a plurality of sentence tags;
splitting the tagged document into a plurality of segments comprising a first segment and a second segment;
implementing a large language model (LLM);
assigning the first segment and the second segment to the LLM in a chronological order;
instructing the LLM to identify and select a first set of relevant tokens within the first segment and then further instructing the LLM to identify and select a second set of relevant tokens within the second segment;
performing at least one from among a prompt-based approach and an attention-based approach that highlights relevant tokens by the LLM from the first set of relevant tokens and from the second set of relevant tokens; and
providing an output of the targeted information from the LLM based on an extraction of the highlighted relevant tokens that is responsive to the query.

2. The method of claim 1, wherein the splitting the tagged document comprises including a sentence from an end portion of a previous segment into a current segment.

3. The method of claim 1, wherein each of the first segment and the second segment has a predetermined chunk token length.

4. The method of claim 1, wherein the selecting the first set of the relevant tokens and the second set of the relevant tokens within the first segment and the second segment comprises selecting predetermined top-k relevant tokens.

5. The method of claim 1, wherein the prompt-based approach comprises:
attaching a predetermined marker to the relevant tokens; and
instantiating the LLM to highlight the relevant tokens based on the attached predetermined marker.

6. The method of claim 1, wherein the attention-based approach comprises:
performing a multi-head attention steering mechanism on a respective layer of the LLM and by modifying attention weights associated with the relevant tokens based on a predetermined multi-head attention function with a predetermined scaling vector; and
highlighting the relevant tokens by the LLM based on the modified attention weights.

7. The method of claim 1, wherein the output includes an intact version of the plurality of sentence tags.

8. A computing apparatus for retrieving targeted information from a document by a large language model, comprising:
a processor;
a memory;
a display; and
a communication interface coupled to each of the processor, the memory, and the display, wherein the processor is configured to:
receive a document having a token length that is greater than a predetermined token length and receive a query for targeted information associated with the document;
tag the document with a plurality of sentence tags;
split the tagged document into a plurality of segments comprising a first segment and a second segment;
implement a large language model (LLM);
assign the first segment and the second segment to the LLM in a chronological order;
instruct the LLM to identify and select a first set of relevant tokens within the first segment and then further instruct the LLM to identify and select a second set of relevant tokens within the second segment;
perform at least one from among a prompt-based approach and an attention-based approach that highlights relevant tokens by the LLM from the first set of relevant tokens and from the second set of relevant tokens; and
provide an output of the targeted information from the LLM based on an extraction of the highlighted relevant tokens that is responsive to the query.

9. The computing apparatus of claim 8, wherein the splitting of the tagged document comprises including a sentence from an end portion of a previous segment into a current segment.

10. The computing apparatus of claim 8, wherein each of the first segment and the second segment has a predetermined chunk token length.

11. The computing apparatus of claim 8, wherein the selecting the first set of the relevant tokens and the second set of the relevant tokens within the first segment and the second segment comprises selecting predetermined top-k relevant tokens.

12. The computing apparatus of claim 8, wherein the processor is further configured to perform the prompt-based approach by:
attaching a predetermined marker to the relevant tokens; and
instantiating the LLM to highlight the relevant tokens based on the attached predetermined marker.

13. The computing apparatus of claim 8, wherein the processor is further configured to perform the attention-based approach by:
performing a multi-head attention steering mechanism on a respective layer of the LLM and by modifying attention weights associated with the relevant tokens based on a predetermined multi-head attention function with a predetermined scaling vector; and
highlighting the relevant tokens by the LLM based on the modified attention weights.

14. The computing apparatus of claim 8, wherein the output includes an intact version of the plurality of sentence tags.

15. A non-transitory computer readable storage medium storing instructions for retrieving targeted information from a document by a large language model, the non-transitory computer readable storage medium comprising executable code which, when executed by a processor, causes the processor to:
receive a document having a token length that is greater than a predetermined token length and receive a query for targeted information associated with the document;
tag the document with a plurality of sentence tags;
split the tagged document into a plurality of segments comprising a first segment and a second segment;
implement a large language model (LLM);
assign the first segment and the second segment to the LLM in a chronological order;
instruct the LLM to identify and select a first set of relevant tokens within the first segment and then further instruct the LLM to identify and select a second set of relevant tokens within the second segment;
perform at least one from among a prompt-based approach and an attention-based approach that highlights relevant tokens by the LLM from the first set of relevant tokens and from the second set of relevant tokens; and
provide an output of the targeted information from the LLM based on an extraction of the highlighted relevant tokens that is responsive to the query.

16. The non-transitory computer readable storage medium of claim 15, wherein the splitting of the tagged document comprises including a sentence from an end portion of a previous segment into a current segment.

17. The non-transitory computer readable storage medium of claim 15, wherein each of the first segment and the second segment has a predetermined chunk token length.

18. The non-transitory computer readable storage medium of claim 15, wherein the selecting the first set of the relevant tokens and the second set of the relevant tokens within the first segment and the second segment comprises selecting predetermined top-k relevant tokens; and
wherein the output includes an intact version of the plurality of sentence tags.

19. The non-transitory computer readable storage medium of claim 15, wherein the executable code further causes the processor to perform the prompt-based approach by:
attaching a predetermined marker to the relevant tokens; and
instantiating the LLM to highlight the relevant tokens based on the attached predetermined marker.

20. The non-transitory computer readable storage medium of claim 15, wherein the executable code further causes the processor to perform the attention-based approach by:
performing a multi-head attention steering mechanism on a respective layer of the LLM and by modifying attention weights associated with the relevant tokens based on a predetermined multi-head attention function with a predetermined scaling vector; and
highlighting the relevant tokens by the LLM based on the modified attention weights.
